(19) United States
(12) Patent Application Publication
(10) Pub. No.: US 2008/0218373 A1
(43) Pub. Date: Sep. 11, 2008

(54) Intelligent keyfob management system

(76) Inventors: William P. Lanigan, Orland Park, IL (US); Maciej Labowicz, Roselle, IL (US); David S. Schuman, Naperville, IL (US); Eugene E. Zhukovsky, Homewood, IL (US); John J. Wepfer, Orland Park, IL (US)

Correspondence Address: Gary J. Cunningham, 620 Courtland Circle, Western Springs, IL, 60558, US

(21) Appl. No.: 11/714,263

(22) Filed: Mar. 6, 2007

(51) Int. Cl. G06F 13/42

(52) U.S. Cl. 340/825

(57) ABSTRACT

An intelligent keyfob management system (300) is disclosed. The system (300) includes the steps of: sending (302) a RF signal having unique serial data from a transmitter; receiving (304) RF signal in a receiver and converting the RF signal to a digital signal; transmitting (306) the digital signal with the unique serial data from the receiver to a microcontroller; providing (308) an editable microcontroller memory including a look up table accessible by an external programming device; verifying (310) whether the unique serial data from the transmitting step matches data populated in the look up table; and performing or refraining from performing (312) a command requested by the transmitter, based on the data in the look up table.

The system (300) is particularly adapted for use with security locks for containers, trailers, and delivery systems using emergency exit doors, and provides an enhanced tool in managing, monitoring and administering RF devices, and particularly keyfobs, typically from a remote or dispatch office location. The look up table can be used to program when an RF device or keyfob is operable or non-operable, and a logging feature can time stamp each device's usage or attempted usage, for later retrieval and analysis, which can be useful for management of RF device fleets and field and delivery personnel.

### BACKGROUND

This invention relates to security systems using radio frequency (RF) receivers and transmitters to control the system operation, including locking and unlocking, door opening and closing processes, tools, and custom software and hardware to manage, administer and monitor a fleet of RF devices.

The RF transmitters and receivers have been used for years to control security systems, such as automatic locks and door openers. All such systems have certain limitations. The main ones are: limited number of transmitters in a system (usually less than 50), inability to identify which transmitter was used in a particular operation, inability to enable and disable or remove a single transmitter out of several programmed for the RF system, inability to log not only performed tasks, but also attempts to use disabled transmitters.

It would be beneficial if a manager could program or pre-select time for each transmitter, when it is enabled and disabled, so that, for example, 1^{st} shift worker could use their transmitters during that shift only.

It would also be considered beneficial, if users were periodically required to enter passwords or a short sequence of key entries to keep their transmitters activated for predetermined amount of time (a work day, for example). If any of them fails to enter the sequence, the transmitter would be disabled. The addition of all these extra features can significantly increase security and reduce unwanted access to cargo being protected by the security system.

A need also exists for a security system that stores a number of event records, such as records of RF transmitter usage, including their serial numbers, and records of the unlocking, locking, door opening or closing, and date, time, air temperature, and/or geographical location of those events. The records need to be updated in such a way, that the new ones would replace the oldest ones, as soon as the maximum number of records allowed was reached.

Furthermore, a need exists for the electronic control system to communicate with an outside world through a unique serial protocol, and provide a user a secure two-way connection using commercially available devices, such as a personal computer (PC), cellular or dial-up modem, or Internet connection, as well as an RF modem. A need exists for a PC software program to communicate with the electronic controller, update its software, adjust features, enable/disable and program input and output devices, calibrate, diagnose problems, and retrieve information records. The user should be able to protect access to the security system by setting and maintaining software passwords.

### SUMMARY

The disclosed apparatus and methods avoid some of the disadvantages of prior devices and add new features. Methods of secure RF communication are already widely used, employing highly secured algorithms, such as KEELOQ® to prevent unauthorized access. Room for improvement exists in post-processing of the decoded data. The invention described herein provides a significant enhancement to this process. Users are allowed to employ a significantly larger number of transmitters, identify each of them, assign names or numbers to them, and record their actions in an event log. Retrieving the recorded log with a personal computer (PC) or PDA allows the user to gather significant data on performance of the whole security system. A typical electronic system for cargo security, its operation, storage of events, retrieval of events, PC software communication program, and licensing process are described in the U.S. Pat. No. 7,091,857 (Electronic Control System Used in Security System for Cargo Trailers), and the system described below represent a significant enhancement to that system. It is assumed, herein, that the reader is familiar with the text of that US patent, so the description used there does not need to be repeated.

The addition of a serial communication link between the RF receiver and the microcontroller controlling the system operation allows an easy transfer of data and switches the keyfob processing from the RF receiver to the microcontroller. The keyfob information is kept in the microcontroller memory and it is continuously available to the control program. The control program also takes care of data verification and fault management, therefore there is a better chance that the system will recognize a partial or corrupted RF transmission and take an appropriate action. An extra backup copy of the keyfob table could be kept in the microcontroller's memory to be used in case of the data corruption of the main table to recover from the fault. If a Global Positioning System (GPS) receiver is connected to the system, keyfob event recording can be followed by the location events for further processing, so that the user knows the serial number of the keyfob, and exact time and location of its use.

A more detailed explanation of the invention is provided in the following description and claims, and is illustrated in the accompanying drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a typical RF keyfob based control system block diagram;

FIG. 2 represents a typical RF receiver processing flowchart;

FIG. 3 represents an enhanced RF keyfob based control system block diagram, in connection with the instant invention;

FIG. 4 represents an enhanced RF receiver processing flowchart, in connection with the instant invention;

FIG. 5 represents a microcontroller keyfob processing flowchart, in connection with the instant invention;

FIG. 6 is the second part of the microcontroller keyfob processing flowchart, in connection with the instant invention;

FIG. 7 represents a keyfob table record structure, in connection with the instant invention;

FIG. 8 represents a typical work schedule entry, in connection with the instant invention;

FIG. 9 shows keyfob management log entries, in connection with the instant invention;

FIG. 10 represents a possible PC keyfob table processing screen, in connection with the instant invention;

FIG. 11 shows a typical keyfob record screen, in connection with the instant invention; and

FIG. 12 represents an enhanced custom RF device and keyfob system flowchart, in connection with the instant invention.

### DETAILED DESCRIPTION

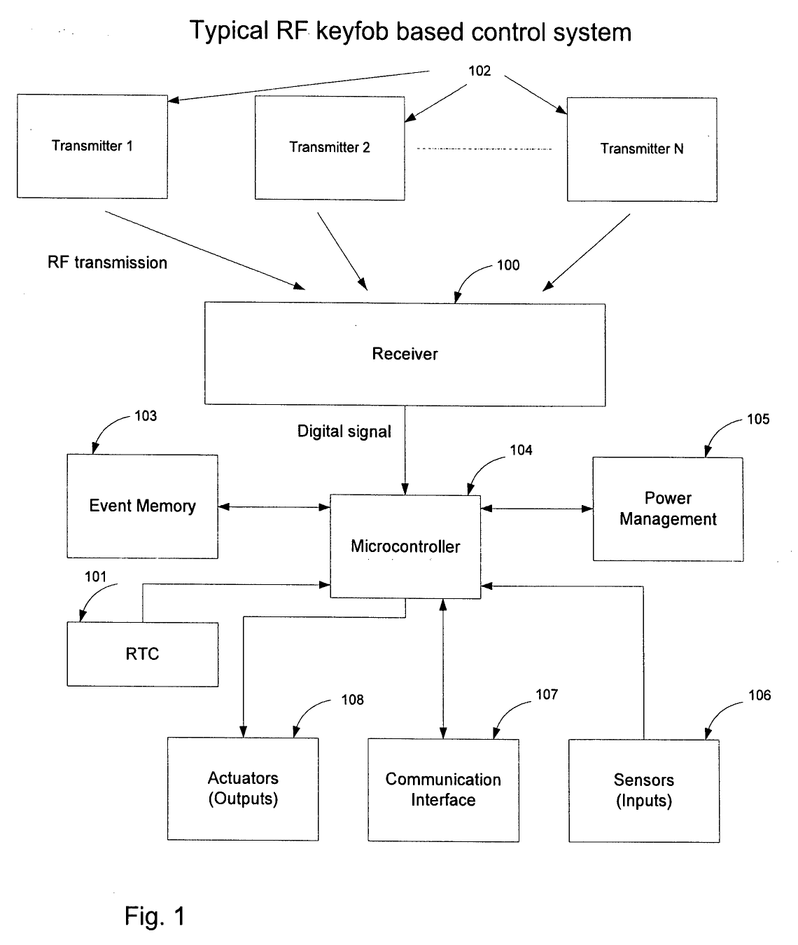

Turning now to the drawings, and more particularly, FIG. 1 thereof, there is a typical RF keyfob system, used in many applications, including security systems, automatic locks, and door openers. It contains an RF receiver 100, several RF transmitters 102, microcontroller 104 with sensors (inputs) 106, actuators (outputs) 108, event memory 103, power management unit 105, real time clock 101, and communication interface 107, such as RS-232. Not shown, but potentially included in such system is a GPS device to provide a location. The transmitters 102 contain one or more pushbutton switches and an electronic circuit to detect switch activations, create serial messages, possibly encrypt them using one of the encrypting schemes (for example KEELOQ®), and send them out using radio frequency link. There may be several (sometimes as many, as 50) independent transmitters 102 working with one receiver 100 in the system, each transmitter with the unique serial number. One transmitter can also work with unlimited number of receivers, since each receiver could be programmed independently.

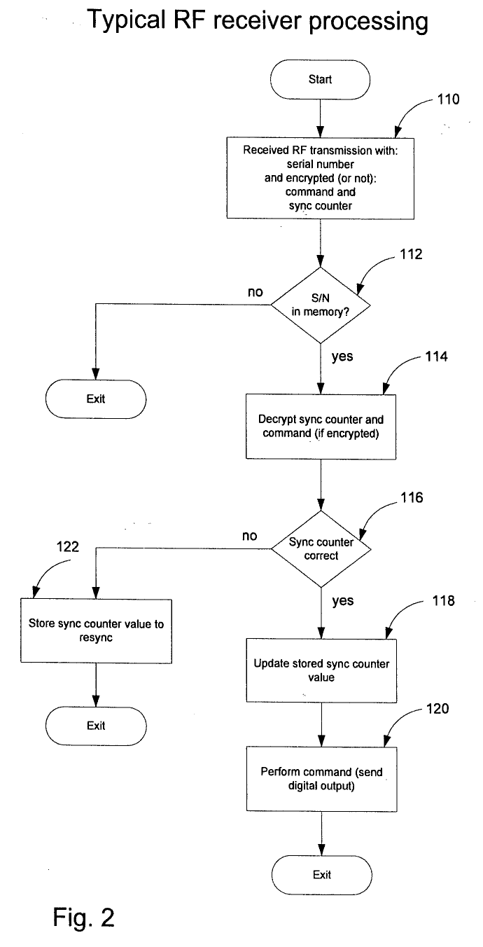

In order to be recognized by the RF keyfob based control system from FIG. 1, the RF transmitters 102 need to be programmed into the RF receiver's 100 memory. When the RF transmission is received (FIG. 2), the receiver converts the RF to digital transmission at 110, verifies at 112 if the transmitter's serial number is in its memory, decrypts the message (if necessary) at 114, and verifies if the transmission is valid, by checking the sync counter value at 116. If the sync counter is used, it is updated at 118, and if the counter is out of sync, the RF receiver stores its present value at 122 for future resynchronization attempt. If the transmission is valid, the RF receiver 100 sends an appropriate digital output at 120 to the microcontroller 104.

The microcontroller 104 uses the RF receiver's digital signals, as well as other inputs from sensors 106, to control the system, via actuators 108. It also uses event memory 103 to store events, real time clock 101 for time stamp, and potentially a GPS receiver for the location stamp.

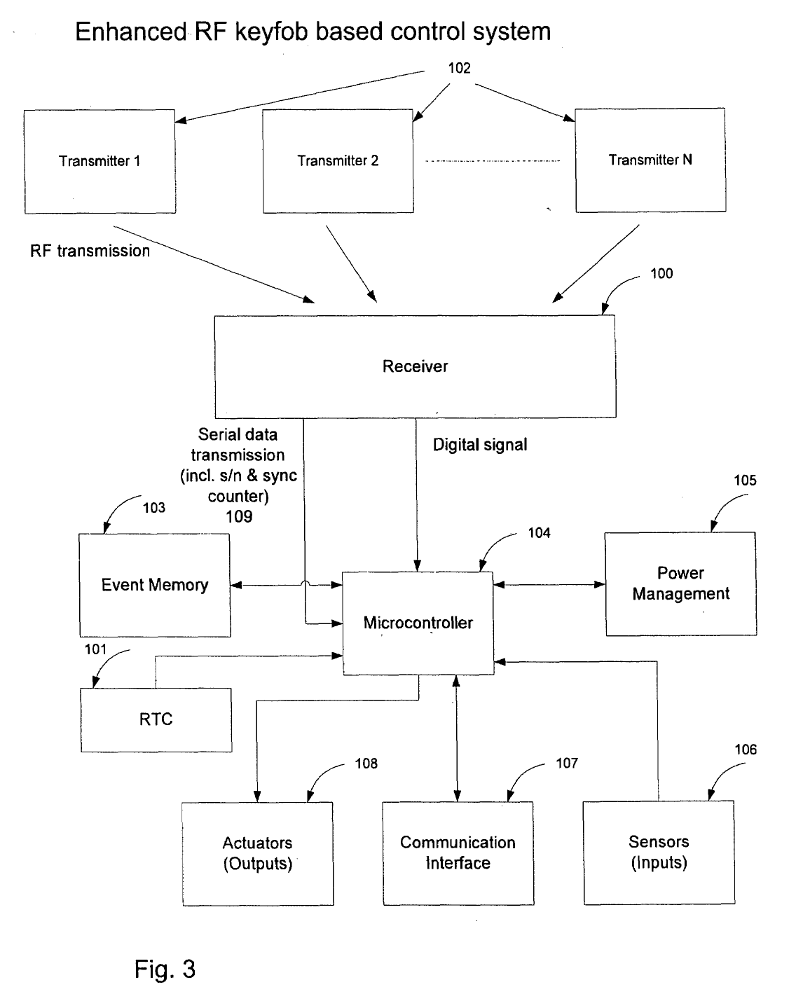

Referring to FIG. 3, the instant invention relates to an RF device management system, and preferably an intelligent custom keyfob management system adapted for use in connection with security locks, emergency exit doors and the like. The system can include: a microcontroller, an RF receiver, RF transmitters, a serial link between the RF receiver and microcontroller, input sensors including GPS position, output actuators, communication interface, event memory, real time clock, power management system to control power sources: main power and battery backup. As shown in FIGS. 3-11, the instant invention provides custom software to manage and administer RF devices, transmitters, transceivers, keyfobs and the like, remotely or in the field, and is particularly useful in connection with keyfobs independently entered in a look up table, by for example, enabling and disabling certain keyfobs, programming when a desired keyfob is operable (i.e. during assigned work hours) or non-operable (i.e. during off hours), and logging each event or attempted event for later retrieval and analysis.

Referring to FIG. 3, an intelligent keyfob management system is shown. The system can include: an RF receiver 100, several RF transmitters 102, microcontroller 104 with sensors (inputs) 106, actuators (outputs) 108, event memory 103, power management unit 105, real time clock 101, and communication interface 107, such as RS-232. Not illustrated in the figures, an optional GPS receiver is included to provide a location stamp for the event log. The RF receiver 102, in addition to standard processing of the RF transmissions, sends the serial data 109 to the microcontroller 104. This happens even if the transmitter's serial number is not stored in the receiver's memory and the standard processing does not send any digital output signals. The serial data transmission 109 contains: the transmitter serial number, the sync counter value, the command requested, and optionally, a transmitter low battery warning. The microcontroller 104 has all digital data from the transmitters 102, necessary to process the transmission independently of the RF receiver 100.

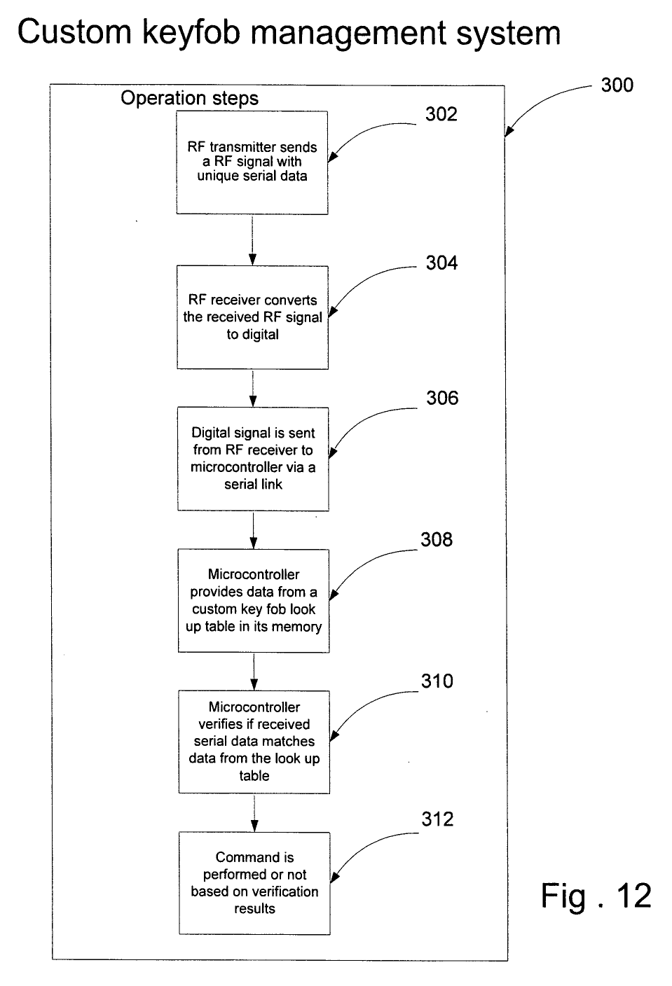

FIG. 12 represents an enhanced, intelligent custom RF device and keyfob system flowchart. The custom keyfob management system (300) includes the steps of: sending 302 a RF signal having unique serial data from a transmitter; receiving 304 RF signal in a receiver and converting the RF signal to a digital signal; transmitting 306 the digital signal with the unique serial data from the receiver to a microcontroller; providing 308 an editable microcontroller memory including a look up table accessible by an external programming device; verifying 310 whether the unique serial data from the transmitting step matches data populated in the look up table; and performing or refraining from performing 312 a command requested by the transmitter, based on the data in the look up table.

The custom or intelligent system 300 is particularly adapted for use with security locks for containers, trailers, and delivery systems using emergency exit doors, and can include: a microcontroller, an RF receiver, several RF transmitters, a serial link between the RF receiver and microcontroller, input sensors including GPS position, output actuators, a communication interface, event memory, real time clock, and optionally, a power management system to control power sources: main power and battery backup. The custom system 300 provides an enhanced tool in managing, monitoring and administering RF devices, and particularly keyfobs, typically from a remote or dispatch office location. Preferably, a look up table can be used to program when an RF device or keyfob is operable or non-operable, and logging each device's usage or attempted usage, for later retrieval and analysis can be useful for management of RF device fleets and field and delivery personnel.

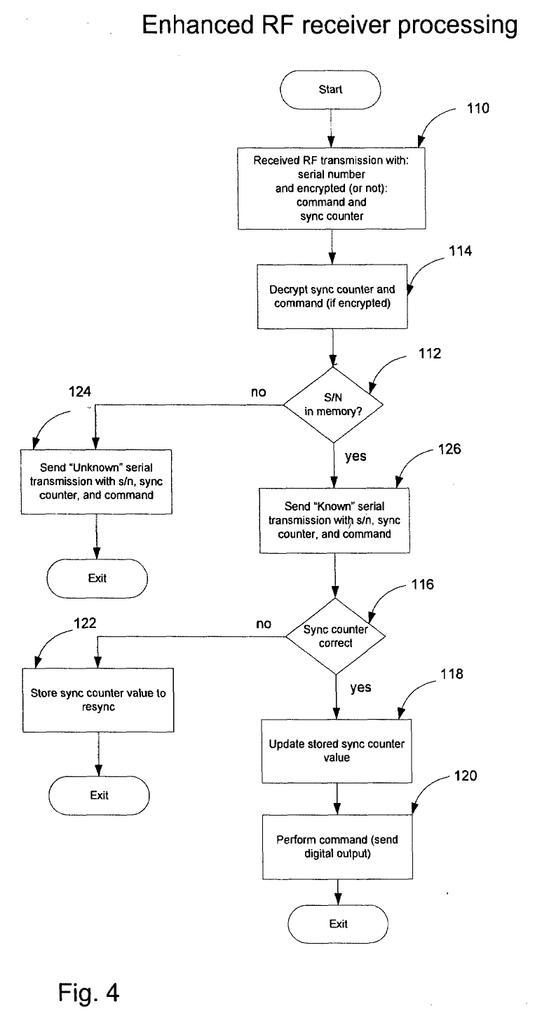

FIG. 4 shows the enhanced RF receiver processing. It should be noted, that a major difference from that shown in FIG. 2, is that in FIG. 4, the receiver decrypts the sync counter and the command at 114 before checking the serial number at 112, because the serial data 109 is sent to the microcontroller 104 all the time, either at 124, or at 126. If the transmitter's serial number is stored in the receiver's memory, the receiver 100 can process data and send the appropriate digital signal output. In that case, the serial transmission data at 126 sent to the microcontroller can be used for additional processing, for example to add the transmitter's serial number to the event log and enhance reporting of events. The receiver 100 verifies if the transmission is valid, by checking the sync counter value at 116. If the sync counter is used, it is updated at 118, and if the counter is out of sync, the RF receiver stores its present value at 122 for future resynchronization attempt. If the transmission is valid, the RF receiver 100 sends an appropriate digital output at 120 to the microcontroller 104.

If the transmitter's serial number is not in the receiver's memory at 112, the serial transmission data is still sent at 124, and total processing is entirely done by the microcontroller 104. In this case, the function of the RF receiver 100 is limited to converting the RF signals and decrypting data. The serial transmission data 109 may include a special character to indicate whether it is “known” or “unknown” to the receiver. For example, it could be a character “K” for “known” and “U” for “unknown”, but any other choice is allowed.

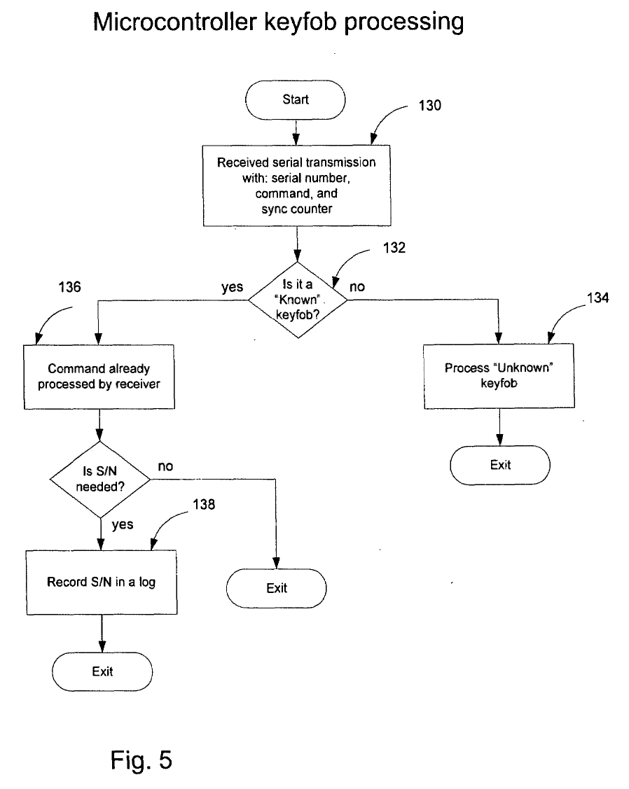

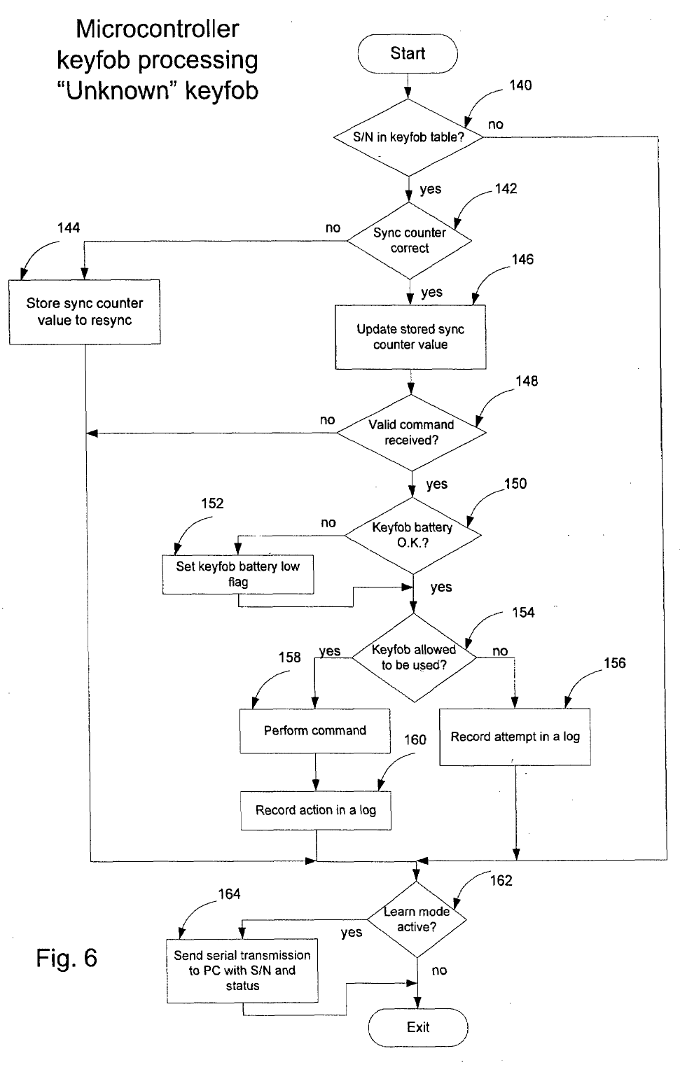

FIG. 5 shows the keyfob serial data transmission processing by the microcontroller 104. The data is received at 130 and checked for “known” or “unknown” characters at 132. If a “known” keyfob is being processed at 136, the command is already executed by the receiver's digital output, and the only task left is to record the event in the log at 138, if desired. If an “unknown” keyfob is detected at 134, its processing is shown in FIG. 6.

FIG. 6 represents the keyfob processing at the microcontroller level. After receiving the serial transmission from the RF receiver 100, the microcontroller 104 checks if the keyfob serial number is included in the keyfob look up table at 140. If not, the microcontroller 104 verifies if a learn (Discovery) mode is active at 162. If so (yes), the microcontroller forwards the entire serial transmission to a personal computer (PC) or a network server at 164 for further processing, including a keyfob look up table creation.

If the keyfob serial number exists in the keyfob table at 140, the sync counter is verified at 142. If the newly received sync counter value is not correct, the microcontroller 104 stores it at 144 in an attempt to resynchronize the counter, otherwise the previously stored value of the sync counter is updated at 146. Next, the pushbutton command is validated at 148 and keyfob battery information is retrieved at 150. If the battery voltage is low, a low battery flag is set at 152. There are other factors at 154 described later, which affect the keyfob by enabling and disabling its operation. If the keyfob is enabled, the command is executed at 158 and the action is recorded in the log at 160. Otherwise, only the attempt to use the keyfob is recorded at 156. If the learn mode is active, the serial transmission is always passed at 164 to the PC.

In order for the keyfob to be recognized by the microcontroller 104, it needs to be entered in the keyfob look up table in the microcontroller's memory. The keyfob look up table can contain a large number of records, such as 1024 or more.

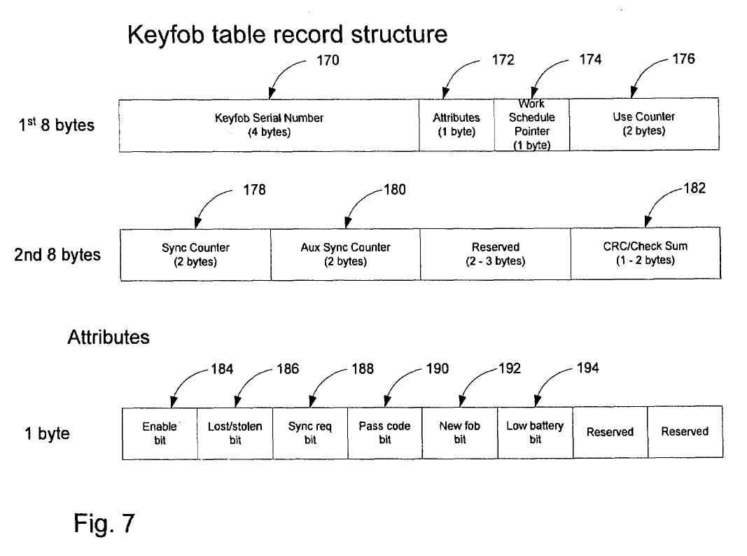

FIG. 7 illustrates a possible keyfob table record structure. For example, the record contains 16 bytes of data including: keyfob serial number 170, attributes 172, work schedule pointer 174, use counter 176, sync counter 178, auxiliary sync counter 180, and CRC (cyclic redundancy check) or checksum data 182 for verification of integrity of the record. The keyfob serial number 170 is unique for each transmitter or keyfob, and it is 4 bytes long in this example. The one-byte attributes may contain: enable bit 184, lost/stolen bit 186, sync required bit 188, pass code bit 190, new keyfob bit 192, and low keyfob battery bit 194. The user or administrator can enable the transmitter by setting the bit 184, or can disable if one is reported as lost or stolen by setting the bit 186. If the out of sync keyfob is used, the microcontroller sets the bit 188 and stores the current transmitter's sync counter in the auxiliary sync counter 180. If the next transmission provides the correct sync counter value, the bit 188 is cleared and the correct sync counter value is transferred to the sync counter 178.

If there is a new transmitter added to the system, the bit 192 is set. Thus, in this way, the microcontroller 104 knows that resynchronization is needed right away to get the correct value of the sync counter 178. The keyfob transmission may contain a bit indicating low transmitter battery—in that case the bit 194 is set.

The pass code bit 190 could be used as an additional keyfob enable bit. The user may be required to enter a password, such as a sequence of pushbutton activations, periodically, for example, every morning to set the bit 190 and enable the transmitter for that day. If a two-button transmitter is used for example, the user may need to press the right button two times, then the left button once, and finally the right button again. The entire sequence must be completed within a certain time period, such as 15 seconds, to set the bit 190 and enable this particular keyfob for the next 8-hour shift. It should be obvious to those skilled in art, that pushbutton sequence, number of keyfob activations in a sequence, time to enter the sequence, and bit 190 enable duration can be altered in this system, without departing from the scope of this invention.

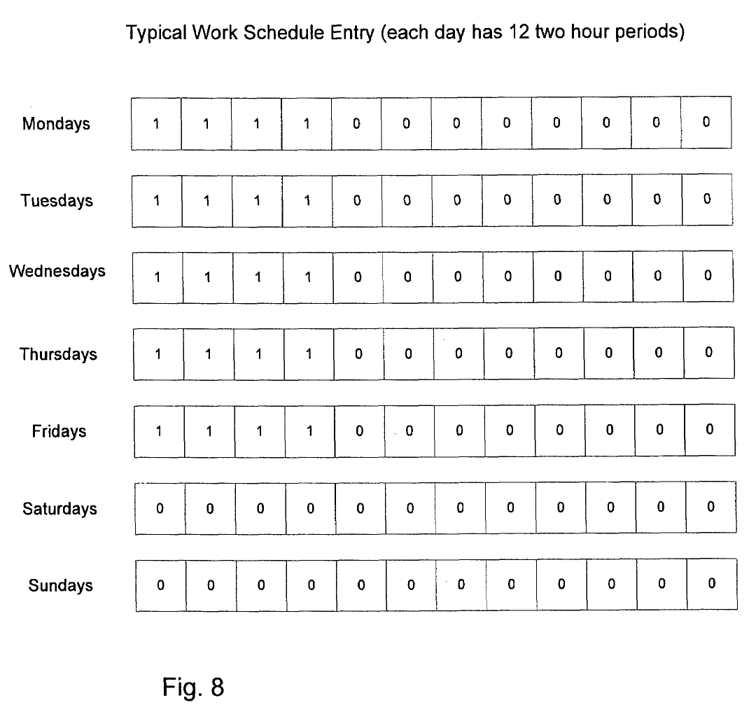

The keyfob table also includes a one-byte work schedule pointer 174 with a value from 0 to 255. Stored in the microcontroller 104 memory (located in either internal, or external event memory 103) are up to 256 tables, like the one shown in FIG. 8 example. Each table entry corresponds to two hours of work—there are enough entries in the single work schedule table to cover the whole week. Zeros in the table are meant to disable the keyfob operation, and ones—to enable it. Therefore, the FIG. 8 work schedule example indicates that only the first 8 hours each day from Monday to Friday are enabled. The user can switch the table by changing the work schedule pointer value 174. The work schedule tables could be preprogrammed by the manufacturer in the program memory, or they can also be input in data memory by a user, for greater flexibility.

Referring back to FIG. 7, a CRC or a checksum register 182 is shown, which is used to verify each record integrity. Different methods could be used for that purpose, but all of them need to be able to indicate that the keyfob table record is corrupted. The microcomputer should be programmed to manage individual record's corruption, by at least disabling its use, or better, by repairing the problem. The easiest way to deal with corrupted records is to keep a redundant (backup) keyfob management table in a different memory location, and keep the backup copy continuously updated. If the corrupted record is encountered in the main table, the backup copy could be utilized and the problem recorded in the log, or the backup, if correct, could be used to repair the main table record. If both records are corrupted, microcontroller software could be developed to analyze both entries and try to recreate the correct record values, since it is unlikely that both records are corrupted the same way.

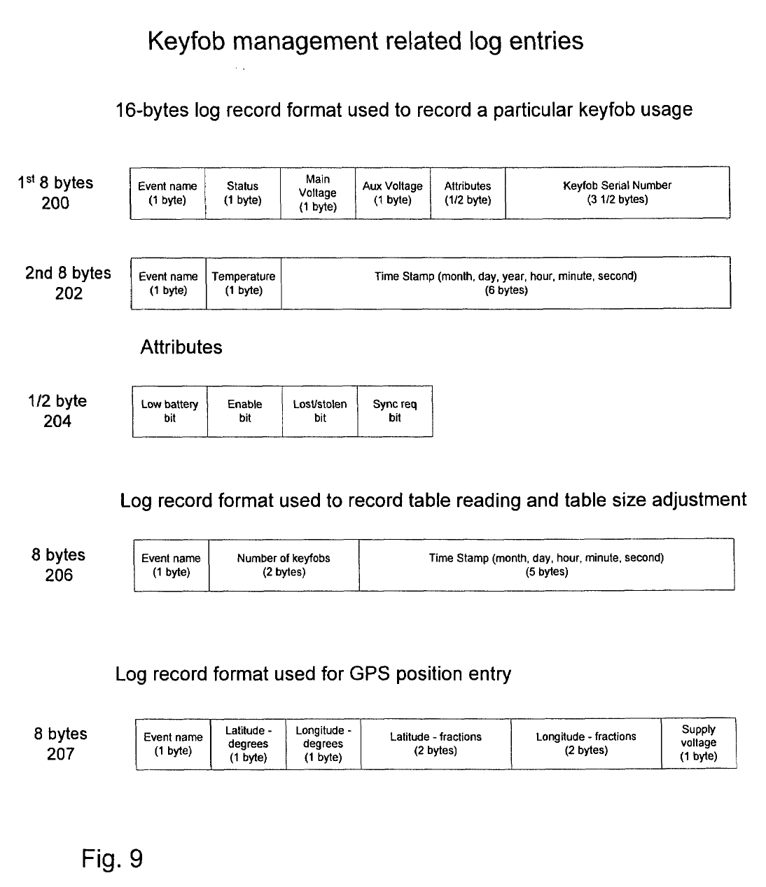

When the microcontroller based keyfob management system is used, for example, the microcontroller 104 stores the keyfob related events in a certain format, shown in FIG. 9. Since the log event memory space may be limited and additional data, such as voltages, temperature, system status, and event time stamp, need to be recorded, it is advantageous to create a special event format, like the one shown in FIG. 9. There are general keyfob management events 206 (not related to a particular keyfob serial number), for example when the keyfob table is read by the PC, or the keyfob table size is written to the microcontroller event memory 103, after updating table entry records. The time stamp used for these events is 5-bytes long, without a byte for a year, to limit the event data to 8 bytes for easy processing at the microcontroller level. The year could be added by the PC program, when it processes other events containing the full 6-byte time stamp. Additionally, there are keyfob events related to a particular serial number, for example locking a door. These events require more memory space since the serial number could be as long as 3, or even 4 bytes. FIG. 9 assumes that the events using keyfob serial numbers are 16 bytes long and the first 8 bytes 200 contain: event name, system status byte, main and auxiliary voltages, 4-bit attributes 204, and a 3.5 byte long serial number. The remaining bytes 202 contain: event name (indicating that it is an extension of a keyfob related event), temperature, and a 6-byte long time stamp, which includes month, day, year, hour, minute, and second. The attributes 204 contain 4 bits transferred from the keyfob table (FIG. 7): a low battery bit, enable bit, lost/stolen bit, and sync required bit. The first 3 bits of attributes 204 are direct transfers of bits 194, 184, and 186. The last bit is a logic sum of bits 188 and 192.

If the system uses a GPS receiver, there are additional log entries related to the GPS position when a keyfob is used. FIG. 9 shows for example a possible GPS entry record 207. This record contains: event name, GPS latitude (degrees), GPS longitude (degrees), GPS latitude (fraction of degrees), GPS longitude (fraction of degrees), and power supply voltage. This record format allows the full GPS position stamp to stay within 8 bytes limit for compatibility with other types of events. Additionally, in a preferred embodiment, the format is compatible with industry standard mapping programs, such as MapQuest, to display the GPS position on a map.

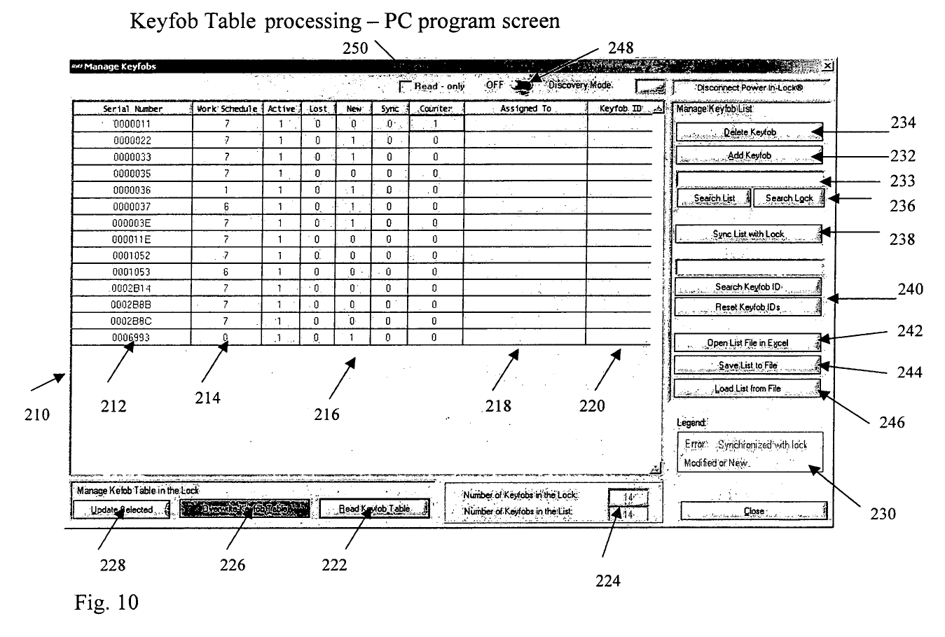

FIG. 10 depicts a possible keyfob table processing PC program screen. A user opens the screen 210 and at this point has three choices: (i) read the keyfob table from the microcontroller 104, (ii) load a previously saved table from a computer file, or (iii) create a new table by typing new keyfob serial numbers at 233 and pressing the “Add Keyfob” button 232. To read the table from the microcontroller's memory the user selects “Read Keyfob Table” 222, and to load the saved list from a file the button “Load List from File” 246 has to be selected. Once the list of keyfobs is displayed on the screen, it can be edited. The list can include the following columns: serial numbers 212, work schedule 214, attributes (enable, lost, new, sync request), and use counter 216. Additionally, if the keyfob table is read from a file, it may contain names of keyfob users at 218 and keyfob numerical ID's at 220. Once the table is displayed, the user can “Add Keyfob” by typing new serial numbers and selecting 232. The user can highlight a line in the table containing a particular keyfob entry and use the “Delete Keyfob” button at 234 to remove that entry. Additionally, a user can perform searches at 236 and 240 for a particular keyfob entry, and verify which keyfob entries in the displayed table correspond to the actual table stored in the microcontroller's memory, by pressing the “Sync List with Lock” button 238. The synchronized entries can be highlighted and displayed in a different color than the ones that have been changed.

Once the user is done editing the keyfob list, he or she can overwrite the entire table in the microcontroller's memory, by pressing the “Overwrite Keyfob Table” button 226, or update the selected single entry by pressing the “Update Selected” button 228. Numbers of keyfobs in each table are displayed at 224—if the list displayed on the screen has a different number of keyfobs, the entire microcontroller table needs an update, since the microcontroller 104 requires the keyfob table entries to be sorted by serial numbers for speedy searches, when the RF signal is received.

The displayed keyfob table can be saved into a file by pressing the “Save List to File” button 244, and also opened by a spreadsheet program, such as MS Excel for further processing, by pressing the “Open List File in Excel” button 242. The Excel file, if its format has not changed, could be loaded back to the table by pressing the “Load List from File” button 246.

Different colors could be used for table records, to indicate modifications, keyfob low battery, or errors in data or record format—a legend at 230 can provide a color explanation for the user.

As earlier mentioned, there is a learn (Discovery) mode selected by changing or setting a position on a toggle like switch 248. If the learn mode is activated, the PC software sends a command to the microcontroller to pass the keyfob serial transmissions to the PC program. The newly received serial numbers from the microcontroller are added to the list at 212, and the list is automatically sorted based on all keyfob serial numbers. If the serial number coming from the microcontroller is already on the list 212, it is highlighted and a message is provided. If the user selects a “Read Only” mode at 250, the learn (Discovery) mode is limited to highlighting the existing keyfob serial numbers, without adding the new ones to the list—the user will be warned that the keyfob just used is not on the list. This feature protects the user from adding new keyfobs to the table, when the intention was only to identify the serial numbers, or the user's names assigned to certain keyfobs.

The keyfob list can contain large number of entries, such as 1024 or more, therefore one cannot assume that serial numbers could be easily found, and changes seen. To protect the user from unintentional changes, the read-only mode and a warning message system can be implemented.

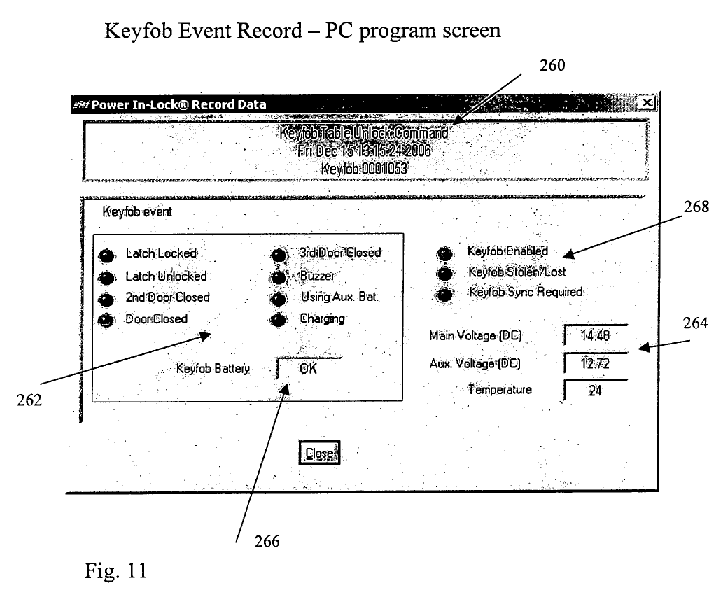

FIG. 11 depicts a possible implementation of the 16-byte keyfob table event record display by the PC program screen. The name of the event is shown at 260, as well as the exact time stamp and the keyfob serial number. The security system status is shown at 262, voltages and temperature at 264, the keyfob battery status at 266, and keyfob attributes at 268.

The control system with the new keyfob management may use a sound-creating device, such as a buzzer, to communicate to a user the current system condition, request acknowledgements, and diagnostic information. The system may also utilize a battery backup to operate the keyfobs and all security devices when the main power is disconnected, or not sufficient. The system can be designed to operate from the main power source even if its voltage is lower than the backup battery voltage, to extend the backup battery useful life. The microcontroller 104 is designed to control through its power management circuit 105 the charging of the backup battery, if the main power source voltage meets an appropriate threshold. If below a certain threshold, no charging occurs, and if above charging is enabled.

The microcontroller 104 is also designed to communicate through its communication interface 107 with a computing device, such as a personal computer, a modem, a wireless link, a PDA or the like. In a preferred embodiment, the computing device uses a serial link, such as RS-232, RS485, USB, or any other available communication link. The user may need to obtain a software license to be able to establish communication between the microcontroller and the computing device mentioned above. A typical PC software communication program and licensing process is described in the U.S. Pat. No. 7,091,857 (Electronic Control System Used in Security System for Cargo Trailers), and is hereby incorporated herein by reference.

In its simplest form, a custom RF device management system is shown and disclosed in FIGS. 3-11. It is particularly adapted for use in connection with keyfobs. The system has at least one RF transmitter, a RF receiver and a microcontroller, and comprises the steps of: sending a RF signal having unique serial data from a transmitter; receiving the RF signal in a receiver and converting the RF signal to a digital signal; transmitting the digital signal with the unique serial data from the receiver to a microcontroller; providing an editable microcontroller memory including a look up table accessible by an external programming device; verifying whether the unique serial data from the transmitting step matches data populated in the look up table; and performing or refraining from performing a command requested by the transmitter, based on the data in the look up table.

The invention allows a user, administrator and the like (herein referred to as a user) to manage and administrate a fleet of transmitters, RF devices, transceivers, keyfobs and the like, and preferably a fleet of keyfobs, without the need to physically touch such devices in the field, for example.

More particularly, the system 300 in FIG. 12, is adapted for use with security locks for containers, trailers, and delivery systems using emergency exit doors, and provides an enhanced tool for managing, monitoring and administering RF devices, and particularly keyfobs, typically from a remote or dispatch office location. The look up table can be used to program when an RF device or keyfob is operable or non-operable, and a logging feature can time stamp each device's usage or attempted usage, for later retrieval and analysis, which can be useful for management of RF device fleets and field and delivery personnel. The performing or refraining from performing step includes entering data by a user, for example, in the look up table so as to enable or disable a desired RF device, and preferably a keyfob. This allows a user to enable real time a particular keyfob (e.g. the particular keyfob is only programmed to operate during a first shift between 9 a.m. and 5 p.m. and a certain field personnel is working overtime and needs to complete assigned deliveries for the day after 5 pm) or disable it (e.g. a keyfob is lost, stolen, or a particular employee has terminated employment and has failed to return his or her assigned RF device or keyfob), typically from an office remote from the keyfob.

In more detail, a user can manage a fleet of keyfobs in real time, by enabling or disabling a desired keyfob, monitoring one or more keyfob users event activity, efficiency and location during the course of a day, week or month, for example. The system can enhance fleet management and administration of RF devices and analysis of potential improvements in field and delivery personnel productivity, real time or at a later date, for example.

In one embodiment, commands or attempted commands are logged from the transmitter or keyfob based on its unique identified serial data. Advantageously, this information can be useful for productivity analysis, process improvements for delivery and field personnel work flow during their normal work shifts and security, to name a few.

In more detail, a real time clock (RTC) can be utilized to accurately record the time of each event or attempted event, and a global position system (GPS) receiver provides the location of each keyfob, in applications when this type of detail is desired.

Advantageously, for improved security, a programmable work schedule entry in the look up table is provided, to allow or restrict time and days of usage for one or more keyfobs. In addition, to enable a certain keyfob, a user may be required to enter a pass code comprising a sequence of predetermined key entries, to enable a particular transmitter or keyfob in the look up table, prior to sending a command.

In one embodiment, detecting a low transmitter battery state, logging that state and alerting a user of that state, can be useful in alerting such users that their RF device or keyfob battery needs to be recharged or otherwise replaced. In a preferred embodiment, the sending step includes sending a sync counter value incremented after each transmission; the verifying step includes comparing the received sync counter value with the stored value in the look up table, and if the verification is valid the look up table value is updated, and otherwise, placing the received sync counter value in temporary storage in an auxiliary sync counter for a future resynchronization attempt; and the performing step includes a command execution only if the sync counter verification is successful. This feature provides advantages in fleet management.

In more detail, the verifying step further includes comparing the received sync counter value to the value from a temporary storage in the auxiliary sync counter, and if the value is verified, performing the desired command and updating the sync counter look up table value, and if the value is not correct, ignoring the received command.

In a preferred embodiment, a custom keyfob management system is disclosed. It includes the steps of: (i) sending a RF signal having unique serial data from a transmitter; (ii) receiving the RF signal in a receiver and converting the RF signal to a digital signal; (iii) transmitting the digital signal with the unique serial data from the receiver to a microcontroller; (iv) providing an editable microcontroller memory including a keyfob look up table accessible by an external computing device; (v) verifying whether the unique serial data from the transmitting step matches data populated in the look up table; (vi) providing at least one record structure in the look up table for at least one keyfob, for recording parameters including at least one of a serial number, attributes, work schedule pointer, use counter, sync counter, auxiliary sync counter, and a cyclic redundancy check or a check sum to verify each record's integrity; and (vii) performing or refraining from performing a command requested by the keyfob, based on the parameters in the look up table. This provides advantages in fleet management.

In one application, the verifying step includes: processing the serial data transmission by the microcontroller, and: (i) if the serial number is known, defined by being stored in the look up table, an actuating signal is triggered and event logging of the requested command occurs; and (ii) if the serial number is unknown, defined by it not being stored in the look up table, and if a learning mode feature is activated, the unknown serial number is stored in a learning mode memory for subsequent processing, whereby a user can update the look up table to transform the unknown serial number which was stored, to a known serial number in the look up table; and (iii) if the serial number is unknown and if the learning mode feature is inactive, the command is processed by the receiver only and ignored by the microcontroller. This is another fleet management feature.

In one application as illustrated in FIG. 8, the verifying step includes: (i) preprogramming a work schedule table with at least one record containing data for each day of the week, and shorter time periods for each day, wherein table entry of one logic level indicates permission to use, and a second logic level indicates lack of permission to use; (ii) using the work schedule pointer from the keyfob look up table and a real time clock, to retrieve the applicable work schedule table entry and (iii) determining if the keyfob is allowed to be used. This structure allows an administrator to preset when the keyfob is enabled or disabled, as appropriate for a certain field worker. Thus, in more detail, during normal work hours it can be enabled and after work hours disabled, as shown in FIG. 8. This feature provides enhanced security for delivery and service companies, desiring keyfobs and RF devices, to only be enabled at certain pre-set times.

In another preferred embodiment, the verifying step includes: (i) detecting potential record corruption by use of the cyclic redundancy check or the check sum; (ii) providing a redundant keyfob management table in a different memory location and substantially continuously updating the redundant management table; (iii) switching to the redundant table when corruption is detected and logging the keyfob management table error to be fixed at a user maintenance interval. This provides yet another fleet management feature, as should be appreciated by those skilled in the art.

The verifying step can include: (i) detecting potential record corruption by use of the cyclic redundancy check or the check sum; (ii) providing a redundant keyfob management table in a unique memory location and substantially continuously updating the redundant management table; (iii) using the redundant table record, if it is correct, to repair the corrupted record in a main table; (iv) logging the keyfob management table error automatically as fixed.

In more detail in FIG. 7, the verifying step can include the look up table having a record structure including: a keyfob serial number, an enable bit to enable the transmitter, lost or stolen bit to disable the transmitter, sync required bit, whereby if a transmitter is out of sync the microcontroller stores the current transmitter's sync counter in an auxiliary sync counter, and if a subsequent transmission provides a correct sync counter value, that clears the sync required bit to allow a correct sync counter value to be transferred to the sync counter, pass code bit, whereby a key fob user is required to enter a predetermined sequence of pushbutton activations (password) to set the pass bit to temporarily enable the transmitter for a certain period of time, and a new keyfob bit.

As illustrated in FIG. 10, the system can further comprise the step of interfacing with the microcontroller's memory, by: coupling an external computing device with the microcontroller's memory; retrieving the keyfob table from the microcontroller memory for at least one of displaying, editing and filing; writing substantially the entire keyfob table, or changes only, back to the microcontroller memory; exporting the retrieved table to a spreadsheet or database program for additional processing, including adding user's names. Advantageously, these features allow a user to dynamically manage and administer a fleet of keyfobs and RF devices.

In one embodiment, the system can include a step of interfacing with the microcontroller's memory, by: coupling an external computing device with the microcontroller's memory; retrieving the keyfob table from the microcontroller memory for displaying, editing, and filing purpose; writing substantially the entire keyfob table, or changes only, back to the microcontroller memory; exporting the retrieved table to a spreadsheet or database program for additional processing, including adding user's names; providing a learning mode feature when activated, to send keyfob serial numbers to the computing device for keyfob table creation and addition to it; providing an automatic sorting of keyfob serial numbers when the new keyfob is added, in order to always write the keyfob table records back to the microcontroller memory in an ascending or descending order for facilitating searching; providing a read only learning mode feature when activated, to send keyfob serial numbers to the computing device for keyfob identification in the keyfob table. These features provide more flexibility and user friendly options for a user.

In yet another embodiment, the step of interfacing with the microcontroller's memory includes: coupling an external computing device with the microcontroller's memory; retrieving the keyfob table from the microcontroller memory for at least one of displaying, editing and filing; and displaying the information for user review including at least one of serial number, work schedule, lost keyfob, new keyfob, sync keyfob, use counter, assigned to and keyfob ID, thereby simplifying the monitoring, administering and managing of a fleet of keyfobs.

The interfacing step can be accomplished by providing a communication interface adapted to allow the microcontroller to communicate with a computing device through a serial communication link including at least one of an RS-232, RS485 and USB.

Advantageously, the system allows easy interfacing with the microcontroller's memory with a fleet control user/administrator, by: recording the serial data in the transmitting step, from the keyfob to the RF receiver, including at least one of transmitter serial number, sync counter, low battery and a button pressed; providing a communication interface adapted to allow the microcontroller to communicate with a computing device; providing a serial communication link, between the microcontroller's memory and the computing device; and managing, administering and monitoring a fleet of keyfobs by a user, either remotely from the keyfobs at a fleet control center or in the field. These features provide enhanced flexibility from a fleet administration and management perspective.

Likewise, the custom system can include the steps of: interfacing with the microcontroller's memory with a fleet control administrator, by: coupling a computing device with the microcomputer's memory; displaying information from the microcontroller's memory on a monitor; and editing and monitoring the information displayed on the monitor, thereby simplifying and expediting the administration and management of a fleet of keyfobs, by including at least one or more and preferably most if not all of the steps of: providing a lost keyfob feature comprising a means for in the event a particular keyfob is lost, the ability to eliminate the particular lost keyfob, without affecting the remaining keyfobs in the fleet; providing a found key fob feature comprising a means for in the event a particular keyfob is found, the ability to reinstate the particular found keyfob, without affecting the remaining keyfobs in the fleet, substantially free from having to reprogram the particular found keyfob; providing a disable keyfob feature comprising a means for in the event a particular disabled keyfob is attempted to be used, the ability to detect and log it's attempted use including time stamping and GPS location; providing a low battery keyfob feature comprising a means for detecting and warning a user of a low keyfob battery condition; providing an individual work schedule keyfob feature comprising a means for setting up an individual work schedule for each user, based on available work schedule tables; providing a pass code keyfob feature comprising a means for authenticating a user by requiring entry of a pass code before a particular keyfob becomes enabled; providing a keyfob logging feature comprising a means for logging important key fob operations for each keyfob in a fleet, including at least one of time stamping, command, GPS position, system status, voltages, temperature, and individual work schedule for each user, based on available work schedule tables; providing a feature to allow an administrator to work substantially independently or with a fleet of keyfobs; providing a feature to allow an administrator to work with PC software and standard spreadsheet programs; and providing a feature to create at least one redundant backup table in the microcontroller's memory, and to check validity of each entry using a cyclic redundancy check and to repair a detected defective entry using the at least one backup table. These steps, features, enhancements and structure, significantly simplify fleet management of transmitters and RF devices, and particularly keyfobs.

Those skilled in the art will recognize that a wide variety of modifications, alterations and combinations can be made with respect to the above described embodiments without departing from the spirit and scope of the invention, and that such modifications etc. are to be viewed as being within the ambit of this invention.

1. An intelligent keyfob management system including at least one RF transmitter, a RF receiver, and a microcontroller, comprising:
sending a RF signal having unique serial data from a transmitter;
receiving the RF signal in a receiver and converting the RF signal to a digital signal;
transmitting the digital signal with the unique serial data from the receiver to a microcontroller;
providing an editable microcontroller memory including a look up table accessible by an external programming device;
verifying whether the unique serial data from the transmitting step matches data populated in the look up table; and
performing or refraining from performing a command requested by the transmitter, based on the data in the look up table.

2. The keyfob management system of claim 1, wherein the performing or refraining from performing step includes entering data in the look up table so as to enable or disable at least one keyfob.

3. The keyfob management system of claim 1, further comprising logging commands or attempted commands from at least one keyfob and identifying each keyfob based on its serial data.

4. The keyfob management system of claim 1, further comprising logging commands or attempted commands from at least one keyfob, identifying each keyfob based on its serial data, and recording time and location of each keyfob event by using a real time clock (RTC) and a global position system (GPS) receiver.

5. The keyfob management system of claim 1, wherein the providing step further includes: providing a programmable work schedule entry in the look up table to allow or restrict time and days of usage of at least one keyfob.

6. The keyfob management system of claim 1, further comprising: requiring a user to enter a pass code comprising a sequence of predetermined key entries, to enable at least one of the transmitters in the look up table prior to sending a command.

7. The keyfob management system of claim 1, further comprising: detecting a low transmitter battery state, logging that state and alerting a user of that state.

8. The keyfob management system of claim 1, further comprising: providing a communication interface adapted to allow the microcontroller to communicate with an external computing device.

9. The keyfob management system of claim 1, further comprising: encrypting the RF signal from the keyfob and decrypting the RF signal in the receiver.

10. The keyfob management system of claim 1, wherein:
the sending step includes sending a sync counter value incremented after each transmission;
the verifying step includes comparing the received sync counter value with the stored value in the look up table, and if the verification is valid the look up table value is updated, and otherwise, placing the received sync counter value in temporary storage in an auxiliary sync counter for a future resynchronization attempt; and
the performing step includes a command execution only if the sync counter verification is successful.

11. The keyfob management system of claim 10, wherein the verifying step further includes comparing the received sync counter value to the value from a temporary storage in the auxiliary sync counter, and if the value is verified, performing the desired command and updating the sync counter look up table value, and if the value is not correct, ignoring the received command.

12. An intelligent keyfob management system including at least one RF transmitter, a RF receiver, and a microcontroller, comprising:
sending a RF signal having unique serial data from a transmitter;
receiving the RF signal in a receiver and converting the RF signal to a digital signal;
transmitting the digital signal with the unique serial data from the receiver to a microcontroller;
providing an editable microcontroller memory including a keyfob look up table accessible by an external computing device;
verifying whether the unique serial data from the transmitting step matches data populated in the look up table;
providing at least one record structure in the look up table for at least one keyfob, for recording parameters including at least one of serial number, attributes, work schedule pointer, use counter, sync counter, auxiliary sync counter, and a cyclic redundancy check or a check sum to verify each record's integrity; and
performing or refraining from performing a command requested by the keyfob, based on the parameters in the look up table.

13. The keyfob management system of claim 12, wherein the performing or refraining from performing step includes entering data in the look up table so as to enable or disable at least one keyfob.

14. The keyfob management system of claim 12, further comprising logging commands or attempted commands from at least one keyfob and identifying each keyfob based on its serial data.

15. The keyfob management system of claim 12, further comprising logging commands or attempted commands from at least one keyfob, identifying each keyfob based on its serial data, and recording time and location of each keyfob event by using a real time clock (RTC) and a global position system (GPS) receiver.

16. The custom keyfob management system of claim 12, wherein the verifying step includes:
processing the serial data transmission by the microcontroller, and:
if the serial number is known, defined by being stored in the look up table, an actuating signal is triggered and event logging of the requested command occurs; and
if the serial number is unknown, defined by it not being stored in the look up table, and if a learning mode feature is activated, the unknown serial number is stored in a learning mode memory for subsequent processing, whereby a user can update the look up table to transform the unknown serial number which was stored, to a known serial number in the look up table; and
if the serial number is unknown and if the learning mode feature is inactive, the command is processed by the receiver only and ignored by the microcontroller.

17. The custom keyfob management system of claim 16, wherein the look up table created in the learning mode on one system and stored in a file can be loaded and utilized in one or more other microcontrollers and keyfob management applications.

18. The custom keyfob management system of claim 12, wherein the verifying step includes:
preprogramming a work schedule table with at least one record containing data for each day of the week, and shorter time periods for each day, wherein table entry of one logic level indicates permission to use, and a second logic level indicates lack of permission to use;
using the work schedule pointer from the keyfob look up table and a real time clock, to retrieve the applicable work schedule table entry and determining if the keyfob is allowed to be used.

19. The custom keyfob management system of claim 12, wherein the verifying step includes:
detecting potential record corruption by use of the cyclic redundancy check or the check sum;
providing a redundant keyfob management table in a different memory location and substantially continuously updating the redundant management table;
switching to the redundant table when corruption is detected and logging the keyfob management table error to be fixed at the user maintenance interval.

20. The custom keyfob management system of claim 12, wherein the verifying step includes:
detecting potential record corruption by use of the cyclic redundancy check or the check sum;
providing a redundant keyfob management table in a unique memory location and substantially continuously updating the redundant management table;
using the redundant table record, if it is correct, to repair the corrupted record in a main table;
logging the keyfob management table error automatically as fixed.

21. The custom keyfob management system of claim 12, wherein the verifying step includes the look up table having a record structure including:
a keyfob serial number,
an enable bit to enable the transmitter,
lost or stolen bit to disable the transmitter,
sync required bit, whereby if a transmitter is out of sync the microcontroller stores the current transmitter's sync counter in an auxiliary sync counter, and if a subsequent transmission provides a correct sync counter value, that clears the sync required bit to allow a correct sync counter value to be transferred to the sync counter,
pass code bit, whereby a key fob user is required to enter a predetermined sequence of pushbutton activations to set the pass bit to temporarily enable the transmitter for a certain period of time, and
new keyfob bit.

22. The custom keyfob management system of claim 12, further comprising:
logging events in an event memory including at least one of an event name, system status, temperature, time stamping, main and auxiliary voltages, and attributes.

23. The custom key fob management system of claim 12, further comprising interfacing with the microcontroller's memory being internal or exterior to the microcontroller.

24. The custom key fob management system of claim 12, further comprising interfacing with the microcontroller's memory, by:
coupling an external computing device with the microcontroller's memory;
retrieving the keyfob table from the microcontroller memory for at least one of displaying, editing and filing;
writing substantially the entire keyfob table, or changes only, back to the microcontroller memory;
exporting the retrieved table to a spreadsheet or database program for additional processing, including adding user's names.

25. The custom keyfob management system of claim 12, further comprising interfacing with the microcontroller's memory, by:
coupling an external computing device with the microcontroller's memory;
retrieving the keyfob table from the microcontroller memory for displaying, editing, and filing purpose;
writing substantially the entire keyfob table, or changes only, back to the microcontroller memory;
exporting the retrieved table to a spreadsheet or database program for additional processing, including adding user's names;
providing a learning mode feature when activated, to send keyfob serial numbers to the computing device for keyfob table creation and addition to it;
providing an automatic sorting of keyfob serial numbers when the new keyfob is added, in order to always write the keyfob table records back to the microcontroller memory in an ascending or descending order for facilitating searching;
providing a read only learning mode feature when activated, to send keyfob serial numbers to the computing device for keyfob identification in the keyfob table.

26. The custom key fob management system of claim 12, further comprising interfacing with the microcontroller's memory, by:
coupling an external computing device with the microcontroller's memory;
retrieving the keyfob table from the microcontroller memory for at least one of displaying, editing and filing; and
displaying the information for user review including at least one of serial number, work schedule, lost keyfob, new keyfob, sync keyfob, use counter, assigned to and keyfob ID, thereby enabling a fleet of keyfobs to be monitored and managed by the user.

27. The custom key fob management system of claim 12, further comprising interfacing with the microcontroller's memory, by providing a communication interface adapted to allow the microcontroller to communicate with a computing device including at least one of a personal computer, a wireless link and a personal data assistant.

28. The custom key fob management system of claim 12, further comprising interfacing with the microcontroller's memory, by providing a communication interface adapted to allow the microcontroller to communicate with a computing device with a serial communication link including at least one of an RS-232, RS485; and USB.

29. The custom keyfob management system of claim 12, further comprising:
interfacing with the microcontroller's memory with a fleet control administrator, by:
recording the serial data in the transmitting step, from the keyfob to the RF receiver, including at least one of transmitter serial number, sync counter, low battery and a button pressed;
providing a communication interface adapted to allow the microcontroller to communicate with a computing device;
providing a serial communication link, between the microcontroller's memory and the computing device; and
managing, administering and monitoring a fleet of keyfobs by a user, either remotely from the keyfobs at a fleet control center or in the field.

30. The custom key fob management system of claim 12, further comprising:
interfacing with the microcontroller's memory with a fleet control administrator, by: coupling a computing device with the microcomputer's memory; displaying information from the microcontroller's memory on a monitor; and editing and monitoring the information displayed on the monitor, thereby administering and managing a fleet of keyfobs, by including at least one or more of:
providing a lost keyfob feature comprising a means for in the event a particular keyfob is lost, the ability to eliminate the particular lost keyfob, without affecting the remaining keyfobs in the fleet;
providing a found key fob feature comprising a means for in the event a particular keyfob is found, the ability to reinstate the particular found keyfob, without affecting the remaining keyfobs in the fleet, substantially free from having to reprogram the particular found keyfob;
providing a disable keyfob feature comprising a means for in the event a particular disabled keyfob is attempted to be used, the ability to detect and log it's attempted use including time stamping and GPS location;
providing a low battery keyfob feature comprising a means for detecting and warning a user of a low keyfob battery condition;
providing an individual work schedule keyfob feature comprising a means for setting up an individual work schedule for each user, based on available work schedule tables;
providing a pass code keyfob feature comprising a means for authenticating a user by requiring entry of a pass code before a particular keyfob becomes enabled;
providing a keyfob logging feature comprising a means for logging important key fob operations for each keyfob in a fleet, including at least one of time stamping, command, GPS position, system status, voltages, temperature, and individual work schedule for each user, based on available work schedule tables;
providing a feature to allow an administrator to work substantially independently or with a fleet of keyfobs;
providing a feature to allow an administrator to work with PC software and standard spreadsheet programs; and
providing a feature to create at least one redundant backup table in the microcontroller's memory, and to check validity of each entry using a cyclic redundancy check and to repair a detected defective entry using the at least one backup table.

31. An intelligent keyfob management system including at least one RF transmitter, a RF receiver, and a microcontroller, comprising:
sending a RF signal having unique serial data from a transmitter;
receiving the RF signal in a receiver and converting the RF signal to a digital signal;
transmitting the digital signal with the unique serial data from the receiver to a microcontroller;
providing an editable microcontroller memory containing a keyfob look up table accessible by an external computing device;
verifying whether the unique serial data from the transmitting step matches data populated in the look up table;
providing at least one sensing input signal to the microcontroller from the RF receiver; and
performing or refraining from performing a command requested by the keyfob, based on at least one of the data in the look up table or at least one sensed input signal to the microcontroller.
